(19) United States
(12) Patent Application Publication
(10) Pub. No.: US 2025/0271729 A1
(43) Pub. Date: Aug. 28, 2025

(54) LENS DRIVE DEVICE AND CAMERA MODULE

(71) Applicant: ALPS ALPINE CO., LTD., Tokyo (JP)

(72) Inventors: Takeshi MURAYAMA, Jiangsu (CN); Takuya KATO, Miyagi (JP)

(21) Appl. No.: 19/055,774

(22) Filed: Feb. 18, 2025

(30) Foreign Application Priority Data
Feb. 22, 2024 (JP) 2024-025880

(51) Int. Cl. G03B 5/00; H04N 23/54; H04N 23/55

(52) U.S. Cl. CPC G03B 5/00; H04N 23/54; H04N 23/55; G03B 2205/0076

(57) ABSTRACT

A lens drive device includes: a base member; a lens holder capable of holding a lens body; and a driver provided between the base member and the lens holder and including a plurality of shape-memory alloy wires configured to vertically move the lens holder at least in an optical-axis direction.

### CROSS-REFERENCE TO RELATED APPLICATIONS

The present application is based on and claims priority to Japanese Patent Application No. 2024-025880 filed on Feb. 22, 2024, the entire contents of which are hereby incorporated by reference.

### BACKGROUND

### 1. Field of the Invention

The present disclosure relates to a lens drive device and a camera module.

### 2. Description of the Related Art

Conventionally, a lens drive device configured to move a lens element (lens holder) by a shape-memory alloy wire is known (see Japanese Laid-Open Patent Application No. 2012-123406). In this lens drive device, both one end and the other end of the shape-memory alloy wire are fixed to a support structure, and an intermediate portion between one end and the other end is hooked to a holding element. The holding element is a part of a metal ring fixed to the lens holder.

### SUMMARY

A lens drive device according to an embodiment of the present disclosure is provided with a base member, a lens holder capable of holding a lens body, and a driver provided between the base member and the lens holder and including a plurality of shape-memory alloy wires configured to vertically move the lens holder at least in an optical-axis direction, wherein the shape-memory alloy wires include a first wire and a third wire that cross each other in a side view as viewed from a first direction orthogonal to an optical-axis, and a second wire and a fourth wire that cross each other in a side view as viewed from a second direction orthogonal to the optical-axis and perpendicular to the first direction, in each of the first wire, the second wire, the third wire, and the fourth wire, one end is fixed to a corresponding lens-side metal member provided on the lens holder, and the other end is fixed to a corresponding base-side metal member provided on the base member, each of the first wire and the second wire is arranged such that a position of the one end is on an upper side of a position of the other end in the optical-axis direction, each of the third wire and the fourth wire is arranged such that a position of the other end is on an upper side of a position of the one end in the optical-axis direction, the lens-side metal members include a first lens-side metal member to which the one end of the first wire is fixed, a second lens-side metal member to which the one end of the second wire is fixed, a third lens-side metal member to which the one end of the third wire is fixed, and a fourth lens-side metal member to which the one end of the fourth wire is fixed, the first lens-side metal member and the second lens-side metal member are conductive and connected in series with the first wire and the second wire, the third lens-side metal member and the fourth lens-side metal member are conductive and connected to the third wire and the fourth wire in series, the first lens-side metal member and the third lens-side metal member are arranged on a first side surface of the lens holder separately and adjacent to each other, and the second lens-side metal member and the fourth lens-side metal member are arranged on a second side surface of the lens holder separately and adjacent to each other.

### BRIEF DESCRIPTION OF THE DRAWINGS

FIG. 1 is a perspective view of a camera module including the lens drive device according to an embodiment of the present disclosure;

FIG. 2 is an exploded perspective view of the lens drive device as illustrated in FIG. 1;

FIG. 3 is a perspective view of the lens holder, the lens-side metal members, and a plate spring;

FIG. 4 is a perspective view of the base member, magnets, the base-side metal members, the plate spring, and flexible metal members;

FIG. 5 is a perspective view of the base member, supported-side metal members, the flexible metal members, and embedded metal members;

FIG. 6 is a perspective view of support-side metal members, the supported-side metal members, the flexible metal members, a support, the embedded metal members, and a magnetic member;

FIG. 7 is a perspective view of the support-side metal members, the support, and the embedded metal members;

FIG. 8 is a side view of the base-side metal members, the lens-side metal members, and the shape-memory alloy wires;

FIG. 9 is perspective views of the base-side metal members, the lens-side metal members, the support-side metal members, the supported-side metal members, the flexible metal members, the embedded metal members, and the shape-memory alloy wires;

FIG. 10 is perspective views of the base-side metal members, the lens-side metal members, the flexible metal members, the embedded metal members, and the shape-memory alloy wires;

FIG. 11 is perspective views of the support-side metal members, the supported-side metal members, the flexible metal members, the embedded metal members, and the shape-memory alloy wires;

FIG. 12 is bottom views of the base member, the flexible metal members, and a second driver; and

FIG. 13 is a bottom view and a cross-sectional view of the base member, the support, and the second driver.

### DETAILED DESCRIPTION OF THE DISCLOSURE

In this lens drive device, when a length of the shape-memory alloy wire changes along with energization to the shape-memory alloy wire, there is a possibility of generating issues related to holding of the shape-memory alloy wire, such as the intermediate portion of the shape-memory alloy wire slides on the holding element and generates wear debris, or that the intermediate portion of the shape-memory alloy wire comes off the holding element when a strong impact such as dropping is applied to the lens drive device.

Therefore, it is desirable to provide a lens drive device capable of suppressing the occurrence of such issues concerning holding of the shape-memory alloy wire.

Hereinafter, a lens drive device 101

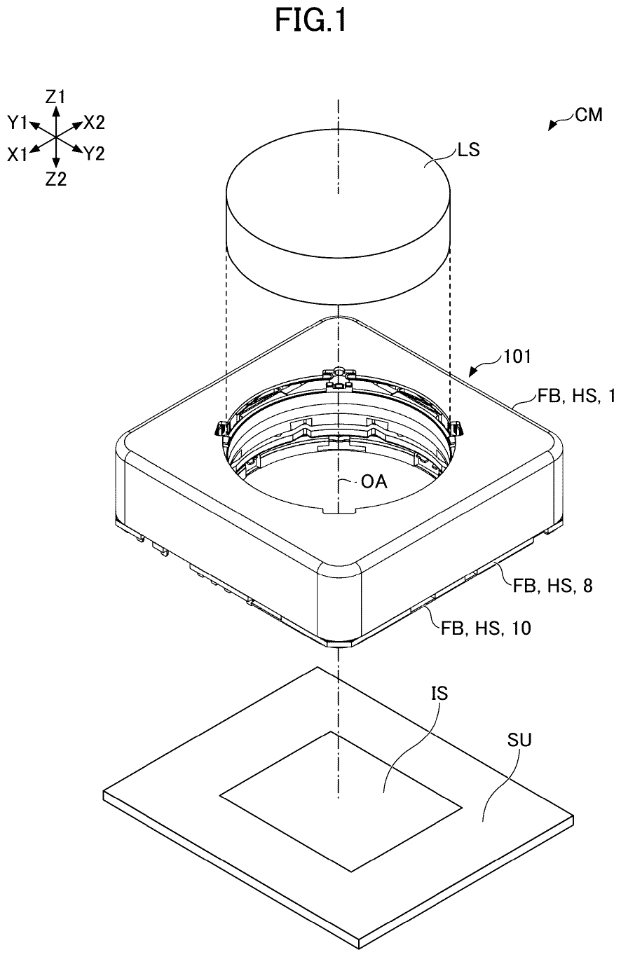

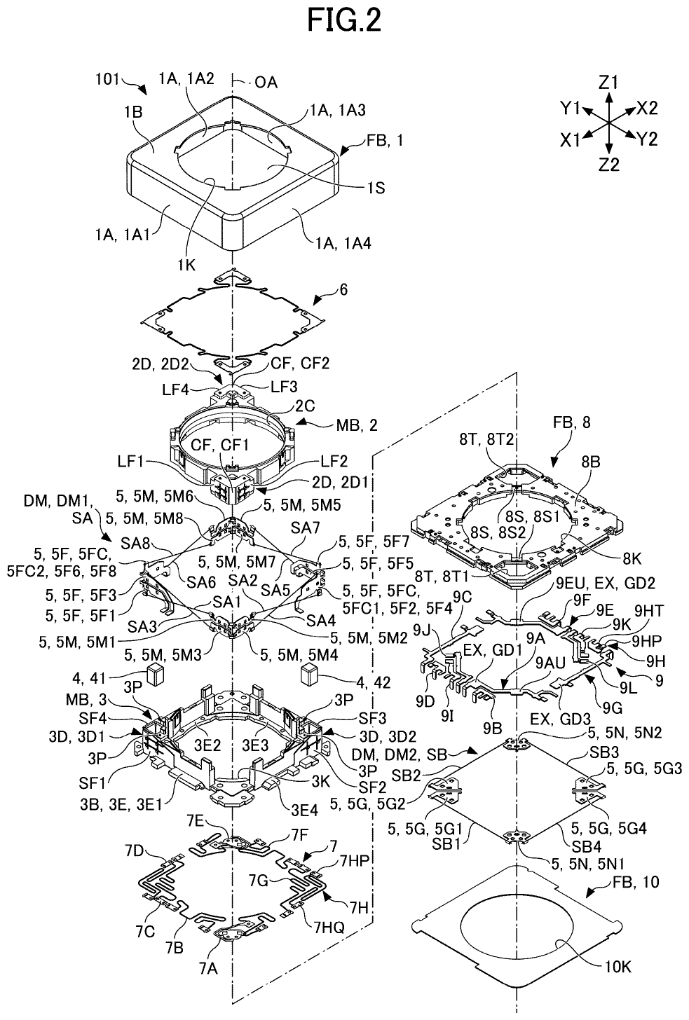

according to an embodiment of the present disclosure will be described with reference to the drawings. FIG. 1 is a perspective view of a camera module CM including a lens drive device 101. FIG. 2 is an exploded perspective view of the lens drive device 101.

In FIGS. 1 and 2, X1 represents one direction of an X-axis of a three-dimensional orthogonal coordinate system, and X2 represents the other direction of the X-axis. Y1 represents one direction of a Y-axis of the three-dimensional orthogonal coordinate system, and Y2 represents the other direction of the Y-axis. Similarly, Z1 represents one direction of a Z-axis of the three-dimensional orthogonal coordinate system, and Z2 represents the other direction of the Z-axis. In FIGS. 1 and 2, an X1 side of the lens drive device 101 corresponds to the front (a front side) of the lens drive device 101, and an X2 side of the lens drive device 101 corresponds to the back (a rear side) of the lens drive device 101. A Y1 side of the lens drive device 101 corresponds to the left side of the lens drive device 101, and a Y2-side of the lens drive device 101 corresponds to the right side of the lens drive device 101. A Z1-side of the lens drive device 101 corresponds to the upper side (a subject side) of the lens drive device 101, and a Z2 side of the lens drive device 101 corresponds to the lower side (an image sensor side) of the lens drive device 101. The same applies in other figures.

As illustrated in FIG. 1, the camera module CM includes a substrate SU, the lens drive device 101, a lens body LS mounted on the lens drive device 101, and an image sensor IS mounted on the substrate SU so as to face the lens body LS. Furthermore, the camera module CM is connected to a controller (not illustrated) which is formed of a microcomputer including a CPU, a memory, and the like. In the illustrated example, the controller is disposed outside the camera module CM, but may be disposed inside the camera module CM. The lens drive device 101 has a substantially rectangular parallelepiped shape and is mounted on the substrate SU on which the image sensor IS is mounted, as illustrated in FIG. 1.

Specifically, as illustrated in FIGS. 1 and 2, the lens drive device 101 includes a cover 1 which is a part of a fixed-side member FB, a support 8, and a magnetic member 10. The cover 1 is configured to function as a part of a housing HS of the lens drive device 101. In the illustrated example, the cover 1 is formed of a non-magnetic metal. However, the cover 1 may be formed of a magnetic metal. As illustrated in FIG. 1, the cover 1 has a bottomless box-like outer shape defining a housing portion 1S.

Specifically, as illustrated in FIG. 2, the cover 1 includes an outer-peripheral wall portion 1A having a rectangular-cylinder shape and a rectangular annular and flat top plate portion 1B provided so as to be continuous with an upper end (Z1-side end) of the outer-peripheral wall portion 1A. A circular opening 1K is formed in the center of the top plate portion 1B. The outer-peripheral wall portion 1A includes a first side-plate portion 1A1 to a fourth side-plate portion 1A4. The first side-plate portion 1A1 and the third side-plate portion 1A3 face each other, and the second side-plate portion 1A2 and the fourth side-plate portion 1A4 face each other. The first side-plate portion 1A1 and third side-plate portion 1A3 extend perpendicularly to the second side-plate portion 1A2 and fourth side-plate portion 1A4. The cover 1, the support 8, and the magnetic member 10 are joined together by an adhesive as illustrated in FIG. 1 and form the housing HS.

As illustrated in FIG. 2, a lens holder 2, a base member 3, magnets 4, metal members 5, a plate spring 6, a flexible metal member 7, the support 8, embedded metal members 9, shape-memory alloy wires SA, shape-memory alloy wires SB, and the like are accommodated between the cover 1 and the magnetic member 10.

The lens holder 2 is a member capable of holding the lens body LS (see FIG. 1) and is included in a movable-side member MB. The lens body LS is, for example, a cylindrical lens barrel including at least one lens, and is configured such that its center axis is along an optical-axis OA.

In the illustrated example, the lens holder 2 is formed by injection molding a synthetic resin such as a liquid crystal polymer (LCP). Specifically, as illustrated in FIG. 2, the lens holder 2 includes a cylindrical portion 2C formed so as to extend along the optical-axis OA and corner portions 2D formed so as to project, respectively, from the cylindrical portion 2C to the outside in a radial direction of a circle centered on the optical-axis OA. The corner portions 2D include a first corner portion 2D1 and a second corner portion 2D2. The first corner portion 2D1 and the second corner portion 2D2 are arranged so as to extend radially opposite to each other across the optical-axis OA. A part of the plate spring 6 is placed on each of the two corner portions 2D.

A driver DM is configured to move the movable-side member MB relative to the fixed-side member FB. In the illustrated example, the driver DM includes the shape-memory alloy wires which are an example of shape-memory actuators. Specifically, the driver DM includes a first driver DM1 for moving the lens holder 2 relative to the base member 3 and a second driver DM2 for moving the base member 3 relative to the support 8. The first driver DM1 includes the shape-memory alloy wires SA, and the second driver DM2 includes the shape-memory alloy wires SB. The shape-memory alloy wires SA include a first wire SA1 to an eighth wire SA8, and the shape-memory alloy wires SB include a first wire SB1 to a fourth wire SB4.

When a current flows, the temperature of the shape-memory alloy wires rises, and the shape-memory alloy wires contract according to the rise in the temperature. Specifically, as illustrated in FIG. 2, each of the shape-memory alloy wires SA is stretched linearly along a corresponding inner surface of the outer-peripheral wall portion 1A of the cover 1 when a current is supplied, such that the lens holder 2 can be moved relative to the base member 3. One end of each of the first wire SAI to the eighth wire SA8 is fixed to corresponding one of lens-side metal members 5M by crimping, welding, etc., and the other end is fixed to corresponding one of base-side metal members 5F by crimping or welding, etc. As illustrated in FIG. 2, the shape-memory alloy wires SB are stretched linearly along the sides of the support 8 when a current is supplied, such that the base member 3 can be moved relative to the support 8. Each of the first wire SB1 to the fourth wire SB4 has one end fixed to corresponding one of supported-side metal members 5N by crimping, welding, etc., and the other end is fixed to corresponding one of support-side metal members 5G by crimping, welding, etc.

In other words, the shape-memory alloy wires SA include the first wire SA1 and the second wire SA2 arranged such that their extension lines cross each other (substantially orthogonally) when viewed in the optical-axis direction (Z-axis direction), the third wire SA3 crossing the first wire SA1 in a side view (front view) when viewed from the first direction (X-axis direction) perpendicular to the optical-axis OA, and the fourth wire SA4 crossing the second wire SA2 in a side view (right-side view) when viewed from the second direction (Y-axis direction) perpendicular to the optical-axis OA and the first direction (X-axis direction), respectively. The shape-memory alloy wires SA include the fifth wire SA5 and the sixth wire SA6 arranged such that their extension lines cross each other (substantially orthogonally) when viewed in the optical-axis direction (Z-axis direction), the seventh wire SA7 crossing the fifth wire SA5 in a side view (rear view) when viewed from the first direction (X-axis direction) perpendicular to the optical-axis OA, and the eighth wire SA8 crossing the sixth wire SA6 in a side view (left side view) when viewed from the second direction (Y-axis direction) perpendicular to the optical-axis OA and the first direction (X-axis direction), respectively. The first wire SB1 and the third wire SB3 face each other across the optical-axis OA, and the second wire SB2 and the fourth wire SB4 face each other across the optical-axis OA. The first wire SB1 and the third wire SB3 are arranged such that their extension lines cross the second wire SB2 and the fourth wire SB4 (substantially orthogonally) when viewed in the optical-axis direction (Z-axis direction). The crossing of two shape-memory alloy wires means that a straight line connecting one end and the other end of one shape-memory alloy wire crosses a straight line connecting one end and the other end of the other shape-memory alloy wire.

The first driver DM1 is configured to move the lens holder 2 up and down in the optical-axis direction (Z-axis direction) which is a direction parallel to the optical-axis OA by utilizing contraction of the shape-memory alloy wires SA. The shape-memory alloy wires SA are configured such that when one or more of the first wire SA1 to the eighth wire SA8 contract, the lens holder 2 moves and another one or the rest of the wires are stretched by the movement. The second driver DM2 is configured to move the base member 3 (including the lens holder 2) back and forth in the first direction (X-axis direction) perpendicular to the optical-axis OA by utilizing the contraction of the shape-memory alloy wires SB, and is capable of moving the base member 3 (including the lens holder 2) left and right in the second direction (Y-axis direction) perpendicular to both the optical-axis OA and the first direction by utilizing the contraction of the shape-memory alloy wires SB. The shape-memory alloy wires SB are configured such that when one or more of the first wire SB1 to the fourth wire SB4 contract, the base member 3 moves, and another one or the rest wires are stretched by the movement.

The base member 3 is a member movable in the X-axis direction and the Y-axis direction with respect to the fixed-side member FB (the support 8), and is included in the movable-side member MB. In the illustrated example, the base member 3 is formed by injection molding by using a synthetic resin such as liquid crystal polymer (LCP). Specifically, the base member 3 has a substantially rectangular outer shape in a top view and includes a substantially circular opening 3K in the center. Specifically, the base member 3 includes a rectangular annular body 3B formed to surround the opening 3K and corner portions 3D projecting upward from the body 3B. The corner portions 3D include a first corner portion 3D1 and a second corner portion 3D2. The first corner portion 3D1 and the second corner portion 3D2 are arranged to face each other in the radial direction across the optical-axis OA. More specifically, the body 3B includes four side portions 3E (a first side portion 3E1 to a fourth side portion 3E4), the first corner portion 3D1 is provided between the first side portion 3E1 and the second side portion 3E2, and the second corner portion 3D2 is provided between the third side portion 3E3 and the fourth side portion 3E4.

The magnets 4 together with the magnetic member 10 fixed to the support 8, suppress separation of the base member 3 from the support 8. Specifically, the magnets 4 are provided on the base member 3 so as to generate a magnetic attractive force between the magnetic member 10 adhered and fixed to the support 8. In the illustrated example, the magnets 4 are permanent magnets that are bipolar magnetized in the Z-axis direction and include a first magnet 41 and a second magnet 42.

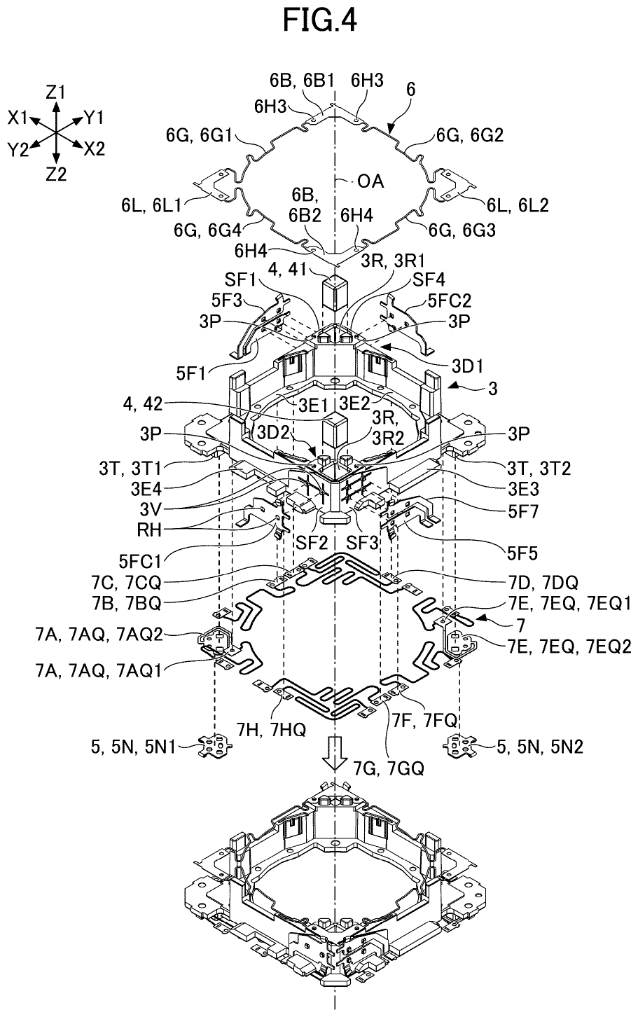

The metal members 5 are configured such that ends of the shape-memory alloy wires can be fixed. In the illustrated example, the metal member 5 is formed of a non-magnetic metal and includes the base-side metal members 5F, the lens-side metal members 5M, the support-side metal members 5G, and the supported-side metal members 5N. The base-side metal members 5F are configured such that each of the base-side metal members 5F is fixed to a corresponding corner portion 3D of the base member 3. The lens-side metal members 5M are configured such that they are fixed to the corner portions 2D of the lens holder 2. The support-side metal members 5G are configured such that they are fixed to a lower surface of the support 8. The supported-side metal members 5N are configured to be fixed to projections 3T (see FIG. 4) projecting downward from a lower surface of the base member 3. The base-side metal members 5F may be embedded in the corner portions 3D of the base member 3, and the lens-side metal members 5M may be embedded in the corner portions 2D of the lens holder 2. The support-side metal members 5G may be embedded in the lower surface of the support 8, and the supported-side metal members 5N may be embedded in the projections 3T of the base member 3.

More specifically, the base-side metal members 5F include a first base-side metal member 5F1 to an eighth base-side metal member 5F8, and the lens-side metal members 5M include a first lens-side metal member 5M1 to an eighth lens-side metal member 5M8. The second base-side metal member 5F2 and the fourth base-side metal member 5F4 are integrated to be included in a common base-side metal member 5FC (a first common base-side metal member 5FC1), and the sixth base-side metal member 5F6 and the eighth base-side metal member 5F8 are integrated to be included in a common base-side metal member 5FC (a second common base-side metal member 5FC2). The support-side metal members 5G include a first support-side metal member 5G1 to a fourth support-side metal member 5G4, and the supported-side metal members 5N include a first supported-side metal member 5N1 and a second supported-side metal member 5N2.

The plate spring 6 is configured to support the lens holder 2 movably in the direction parallel to the optical-axis OA with respect to the base member 3. In the present embodiment, the plate spring 6 is made of a metal plate mainly made of, for example, a copper alloy, a titanium-copper alloy (titanium-copper), or a copper-nickel alloy (nickel-tin copper). In the illustrated example, the plate spring 6 connects the lens holder 2 and the base member 3 such that the center of the lens holder 2 and the center of the base member 3 coincide in a neutral state of the lens drive device 101. Specifically, the plate spring 6 is configured to connect the corner portions 2D formed in the lens holder 2 and the corner portions 3D formed in the base member 3. The neutral state of the lens drive device 101 is, for example, a state in which a current is supplied to each of the first wire SA1 to the eighth wire SA8 and the first wire SB1 to the fourth wire SB4, and the movable-side members MB (the lens holder 2 and the base member 3) are positioned in the middle of a movable range in each of the three axes (X-axis, Y-axis, and Z-axis) orthogonal to each other, that is, the movable-side members MB (the lens holder 2 and the base member 3) are in neutral positions. Typically, in the neutral state of the lens drive device 101, the lens holder 2 is positioned in the center of the movable range in each of the three axes, and the base member 3 is positioned in the center of the movable range in each of the two axes (X-axis and Y-axis).

The flexible metal member 7 is a member configured to supply current to each of the shape-memory alloy wires SA and SB. Specifically, the flexible metal member 7 includes fixed joint portions fixed to the support 8, movable joint portions fixed to the base member 3, and elastically-deformable elastic arms connecting the fixed joint portions and the movable joint portions. In the illustrated example, the flexible metal member 7 includes a first flexible metal member 7A to an eighth flexible metal member 7H.

The support 8 is a member for supporting the movable-side member MB and is included in the fixed-side member FB. In the illustrated example, the support 8 is formed by injection molding by using a synthetic resin such as liquid crystal polymer (LCP). Specifically, the support 8 has a substantially rectangular outer shape in a top view and includes a substantially circular opening 8K in the center. The support 8 includes a rectangular annular base 8B formed so as to surround the opening 8K.

The embedded metal members 9 are members embedded in the support 8. Specifically, each of the embedded metal members 9 includes a terminal used for electrical connection with the outside and a joint portion exposed from a surface of the support 8 and used for joining together with other metal members. In the illustrated example, the embedded metal members 9 include a first embedded metal member 9A to a twelfth embedded metal member 9L.

The magnetic member 10 together with the magnets 4 fixed to the base member 3 suppresses the separation of the base member 3 from the support 8. In the illustrated example, the magnetic member 10 is a rectangular annular and flat metal plate formed of a magnetic metal. However, the magnetic member 10 may be a magnet, and may be formed of a magnetic resin material or the like as long as it can generate a magnetic attractive force between the magnetic member 10 and the magnets 4. The magnetic member 10 may be embedded in the support 8 by insert molding or the like. Specifically, the magnetic member 10 has a substantially rectangular outer shape in a top view and includes a substantially circular opening 10K in the center.

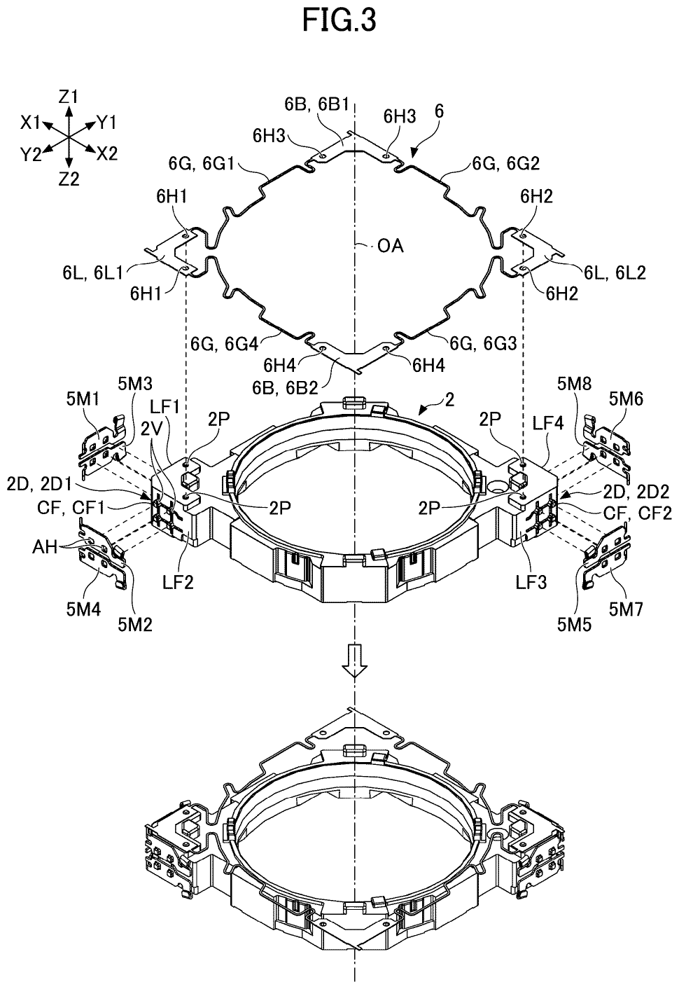

Next, with reference to FIG. 3, the positional relationship between a member attached to the lens holder 2 and the lens holder 2 will be described. FIG. 3 is a perspective view of the lens holder 2, the lens-side metal members 5M, and the plate spring 6. Specifically, the upper figure of FIG. 3 (the figure illustrated above the block arrow) is an exploded perspective view of the lens holder 2, the lens-side metal members 5M, and the plate spring 6, and the lower figure of FIG. 3 (the figure illustrated below the block arrow) is an assembled perspective view of the lens holder 2, the lens-side metal members 5M, and the plate spring 6.

In the example as illustrated in the upper figure of FIG. 3, the second lens-side metal member 5M2 is fixed to an upper part of a second side surface LF2, which is an outer surface of the Y2-side sidewall of the first corner portion 2D1. Specifically, the second lens-side metal member 5M2 is fixed to the first corner portion 2D1 by an adhesive in a state where two rectangular projections 2V formed in the first corner portion 2D1 and projecting outward (the Y2-side) and two rectangular holes AH formed in the second lens-side metal member 5M2 are engaged. The adhesive is, for example, a photo-curable adhesive. The photo-curable adhesive is, for example, an ultraviolet-curable adhesive or a visible-light-curable adhesive. Similarly, the first lens-side metal member 5M1 is fixed to an upper part of a first side surface LF1 which is the outer surface of an X1-side sidewall of the first corner portion 2D1, the third lens-side metal member 5M3 is fixed to a lower part of the first side surface LF1, and the fourth lens-side metal member 5M4 is fixed to a lower part of the second side surface LF2. The fifth lens-side metal member 5M5 is fixed to an upper part of a third side surface LF3 which is an outer surface of an X2-side sidewall of the second corner portion 2D2, the sixth lens-side metal member 5M6 is fixed to an upper part of a fourth side surface LF4 which is an outer surface of a Y1-side sidewall of the second corner portion 2D2, the seventh lens-side metal member 5M7 is fixed to a lower part of the third side surface LF3, and the eighth lens-side metal member 5M8 is fixed to a lower part of the fourth side surface LF4.

The plate spring 6 includes base-side portions 6B fixed to the corner portions 3D (see FIG. 2) of the base member 3, lens-side portions 6L fixed to the corner portions 2D of the lens holder 2, and elastic portions 6G connecting the base-side portions 6B and the lens-side portions 6L. Specifically, the base-side portions 6B include a first base-side portion 6B1 and a second base-side portion 6B2, the lens-side portions 6L include a first lens-side portion 6L1 and a second lens-side portion 6L2, and the elastic portions 6G include a first elastic portion 6G1 to a fourth elastic portion 6G4. The first elastic portion 6G1 connects the first lens-side portion 6L1 and the first base-side portion 6B1, the second elastic portion 6G2 connects the first base-side portion 6B1 and the second lens-side portion 6L2, the third elastic portion 6G3 connects the second lens-side portion 6L2 and the second base-side portion 6B2, and the fourth elastic portion 6G4 connects the second base-side portion 6B2 and the first lens-side portion 6L1.

The first lens-side portion 6L1 is formed with two first through-holes 6H1 through which two round projections 2P formed on the upper surface of the first corner portion 2D1 and projecting upward are inserted. In the second lens-side portion 6L2, two second through-holes 6H2 are formed through which the two round projections 2P formed on an upper surface of the second corner portion 2D2 and projecting upward are inserted. In the illustrated example, the joining of the plate spring 6 and the projections 2P is achieved by an adhesive. However, the joining of the plate spring 6 and the projections 2P may be achieved by applying heat caulking or cold caulking to the projections 2P.

Similarly, in the first base-side portion 6B1, two third through-holes 6H3 through which two round projections 3P (see FIG. 4) formed on an upper surface of the first corner portion 3D1 (see FIG. 4) and projecting upward are inserted. In the second base-side portion 6B2, two fourth through-holes 6H4 through which two round projections 3P (see FIG. 2) formed on an upper surface of the second corner portion 3D2 and projecting upward are inserted. In the illustrated example, joining of the plate spring 6 and the projections 3P is achieved by an adhesive. However, the joining of the plate spring 6 and the projections 3P may be achieved by applying heat caulking or cold caulking to the projections 3P.

As illustrated in FIG. 3, the plate spring 6 is formed to be rotationally symmetric twice with respect to the optical-axis OA. Therefore, the plate spring 6 can support the lens holder 2 in the air in a balanced manner. Moreover, the plate spring 6 does not adversely affect the weight balance of the movable-side member MB (the lens holder 2) supported by the eight shape-memory alloy wires SA (the first wire SA1 to the eighth wire SA8).

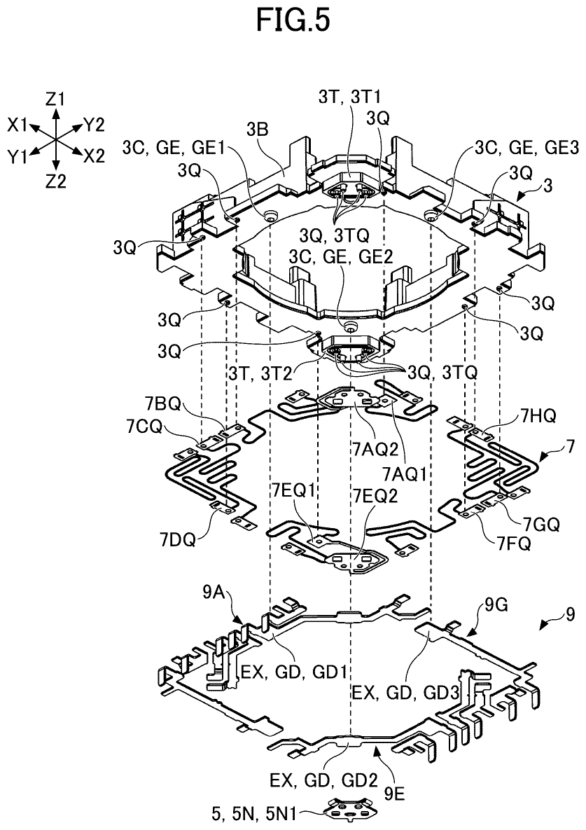

Next, with reference to FIGS. 4 and 5, a positional relationship between members contacting the base member 3 and the base member 3 will be described. FIG. 4 is an upper perspective view of the base member 3, the magnets 4, the base-side metal members 5F, the supported-side metal members 5N, the plate spring 6, and the flexible metal member 7. Specifically, the upper figure of FIG. 4 (the figure above the block arrow) is an exploded perspective view of the base member 3, the magnets 4, the base-side metal members 5F, the supported-side metal members 5N, the plate spring 6, and the flexible metal member 7, and the lower figure of FIG. 4 (the figure below the block arrow) is an assembled perspective view of the base member 3, the magnets 4, the base-side metal members 5F, the supported-side metal members 5N, the plate spring 6, and the flexible metal member 7. FIG. 5 is a lower perspective view of the base member 3, the supported-side metal members 5N, the flexible metal member 7, and the embedded metal members 9.

As illustrated in the upper figure of FIG. 4, casing portions 3R opening upward (Z1 direction) are formed in the corner portions 3D of the base member 3. The magnets 4 are respectively received by the corresponding casing portion 3R and fixed thereto by an adhesive. Specifically, a first casing portion 3R1 is formed in the first corner portion 3D1 and a second casing portion 3R2 is formed in the second corner portion 3D2. A first magnet 41 is received by the first casing portion 3R1 and a second magnet 42 is received by the second casing portion 3R2.

In the example as illustrated in the upper figure of FIG. 4, the first common base-side metal member 5FC1 is fixed to a second side surface SF2 which is an outer surface of the Y2-side sidewall of the second corner portion 3D2 arranged along the fourth side portion 3E4 of the base member 3. Specifically, the first common base-side metal member 5FC1 is fixed to the second corner portion 3D2 by an adhesive in a state where two rectangular projections 3V formed in the second corner portion 3D2 and projecting outward (the Y2-side) and two rectangular holes RH formed in the first common base-side metal member 5FC1 are engaged. Similarly, the second common base-side metal member 5FC2 is fixed to a fourth side surface SF4, which is an outer surface of the Y1-side sidewall of the first corner portion 3D1 disposed along the second side portion 3E2 of the base member 3, the first base-side metal member 5F1 is fixed to a lower part of a first side surface SF1, which is the outer surface of the X1-side sidewall of the first corner portion 3D1 disposed along the first side portion 3E1 of the base member 3, the third base-side metal member 5F3 is fixed to an upper part of the first side surface SF1, the fifth base-side metal member 5F5 is fixed to a lower part of a third side surface SF3, which is an outer surface of the X2-side sidewall of the second corner portion 3D2 disposed along the third side portion 3E3 of the base member 3, and the seventh base-side metal member 5F7 is fixed to an upper part of the third side surface SF3.

The first flexible metal member 7A to the eighth flexible metal member 7H include a first movable joint portion 7AQ to an eighth movable joint portion 7HQ, respectively. The first movable joint portion 7AQ includes a first inner movable joint portion 7AQ1 and a first outer movable joint portion 7AQ2, and the fifth movable joint portion 7EQ includes a fifth inner movable joint portion 7EQ1 and a fifth outer movable joint portion 7EQ2.

As illustrated in FIG. 5, a through-hole is formed in the eighth movable joint portion 7HQ through which a round projection 3Q formed on the lower surface of the base member 3 and projecting downward is inserted. In the illustrated example, the joining between the flexible metal member 7 (the eighth movable joint portion 7HQ) and the base member 3 (the projection 3Q) is achieved by an adhesive. However, the joining between the flexible metal member 7 (the eighth movable joint portion 7HQ) and the base member 3 (the projection 3Q) may be achieved by applying heat caulking or cold caulking to the projection 3Q. The same applies to the first movable joint portion 7AQ to the seventh movable joint portion 7GQ.

As illustrated in FIG. 5, the projections 3T are formed on the lower surface of the base member 3. The projections 3T include a first projection 3T1 and a second projection 3T2. In addition, four through-holes are formed in the first outer movable joint portion 7AQ2 through which the four projections 3Q (projections 3TQ) formed on the lower surface of the first projection 3T1 and projecting downward therefrom are inserted. The first outer movable joint portion 7AQ2 and the projections 3TQ are joined together by an adhesive. However, the first outer movable joint portion 7AQ2 and the projections 3TQ may be joined together by applying heat caulking or cold caulking to the projections 3TQ.

As illustrated in FIG. 4, each of a second movable joint portion 7BQ to a fourth movable joint portion 7DQ and a sixth movable joint portion 7FQ to an eighth movable joint portion 7HQ includes a rounded-corner rectangular through-hole used in welding. The second movable joint portion 7BQ and the third base-side metal member 5F3 are joined together by welding. However, the second movable joint portion 7BQ and the third base-side metal member 5F3 may be joined together by a conductive adhesive or the like. The same applies to the joining of the third movable joint portion 7CQ and the first base-side metal member 5F1, the joining of the fourth movable joint portion 7DQ and the second common base-side metal member 5FC2, the joining of the sixth movable joint portion 7FQ and the seventh base-side metal member 5F7, the joining of the seventh movable joint portion 7GQ and the fifth base-side metal member 5F5, and the joining of the eighth movable joint portion 7HQ and the first common base-side metal member 5FC1.

The supported-side metal members 5N are fixed to the lower end surfaces of the projections 3T of the base member 3 with the corresponding flexible metal member 7 sandwiched therebetween. Specifically, the first supported-side metal member 5N1 is fixed to the first projection 3T1 with the first outer movable joint portion 7AQ2 sandwiched therebetween, and the second supported-side metal member 5N2 is fixed to the second projection 3T2 with the fifth outer movable joint portion 7EQ2 sandwiched therebetween. More specifically, each of the first supported-side metal member 5N1 and the first outer movable joint portion 7AQ2 includes four through-holes through which the four projections 3TQ formed on a lower-end surface of the first projection 3T1 are inserted. The first supported-side metal member 5N1, the first outer movable joint portion 7AQ2, and the first projection 3T1 are joined together by an adhesive. However, the joining of the first supported-side metal member 5N1, the first outer movable joint portion 7AQ2, and the first projection 3T1 may be achieved by applying heat caulking or cold caulking to the projections 3TQ. Furthermore, the first supported-side metal member 5N1 is formed with the rounded-corner rectangular through-holes used in welding. The joining of the first supported-side metal member 5N1 and the first outer movable joint portion 7AQ2 is achieved by welding. However, the joining of the first supported-side metal member 5N1 and the first outer movable joint portion 7AQ2 may be achieved by a conductive adhesive or the like. The same applies to the joining of the second supported-side metal member 5N2, the fifth outer movable joint portion 7EQ2, and the second projection 3T2.

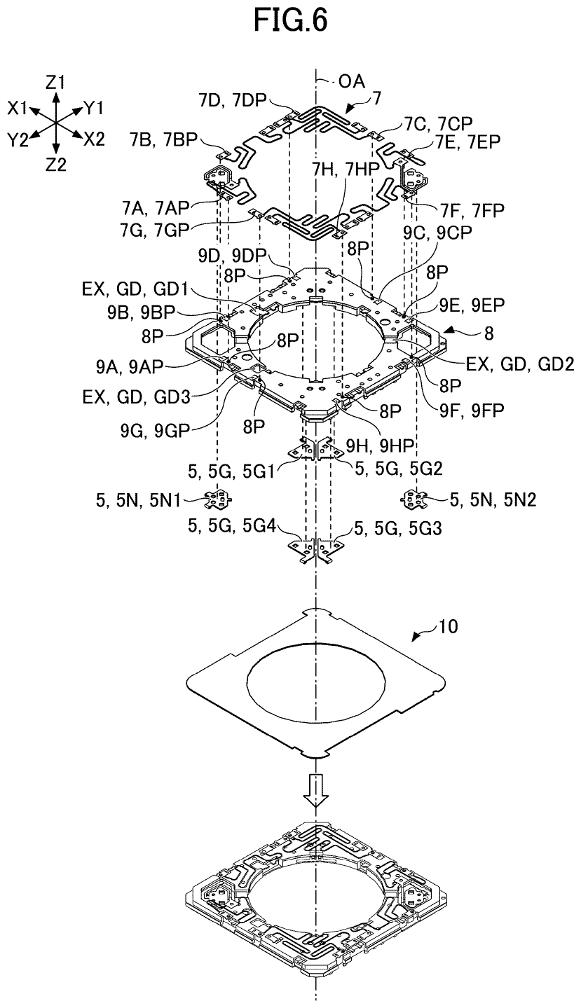

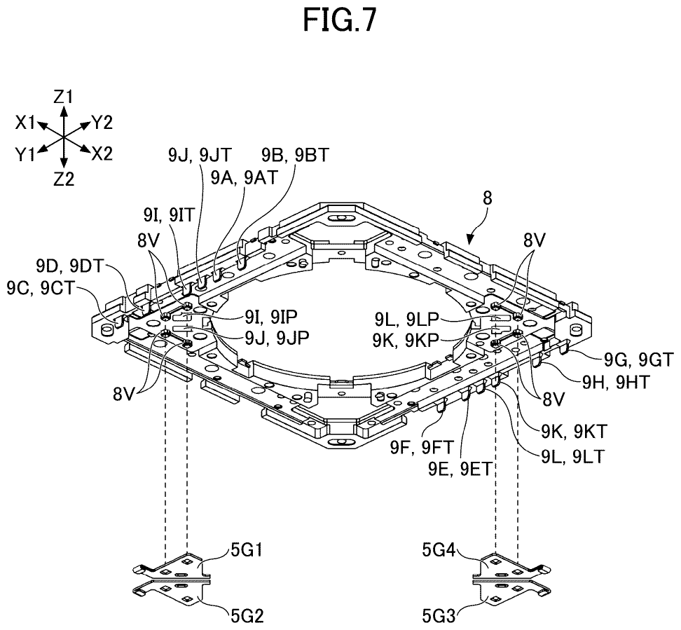

Next, with reference to FIGS. 6 and 7, a positional relationship between members attached to the support 8 and the support 8 will be described. FIG. 6 is the upper perspective view of the support-side metal members 5G, the supported-side metal members 5N, the flexible metal member 7, the support 8, the embedded metal members 9, and the magnetic member 10. Specifically, the upper figure of FIG. 6 (the figure above the block arrow) is an exploded perspective view of the support-side metal members 5G, the supported-side metal members 5N, the flexible metal member 7, the support 8 in which the embedded metal members 9 are embedded, and the magnetic member 10. The lower figure of FIG. 4 (the figure below the block arrow) is the assembled perspective view of the support-side metal members 5G, the supported-side metal members 5N, the flexible metal member 7, the support 8, the embedded metal members 9, and the magnetic member 10. FIG. 7 is a lower perspective view of the support-side metal members 5G, the support 8, and the embedded metal members 9. The magnetic member 10 is adhered and fixed to the support 8 so as not to contact either the support-side metal members 5G or the supported-side metal members 5N. The supported-side metal members 5N are not directly attached to the support 8, but are illustrated in FIG. 6 for ease of understanding.

As illustrated in FIGS. 6 and 7, the first flexible metal member 7A to the eighth flexible metal member 7H include a first fixed joint portion 7AP to an eighth fixed joint portion 7HP, respectively. The first embedded metal member 9A to the twelfth embedded metal member 9L include a first terminal 9AT to a twelfth terminal 9LT and a first joint portion 9AP to a twelfth joint portion 9LP, respectively.

The first fixed joint portion 7AP is formed with a through-hole through which a round projection 8P formed on the upper surface of the support 8 and projecting upward is inserted. In the illustrated example, the joining between the flexible metal member 7 (the first fixed joint portion 7AP) and the support 8 (the projection 8P) is achieved by an adhesive. However, the joining between the flexible metal member 7 (the first fixed joint portion 7AP) and the support 8 (the projection 8P) may be achieved by heat caulking or cold caulking the projection 8P. The same applies to the second fixed joint portion 7BP to the eighth fixed joint portion 7HP.

Each of the first fixed joint portion 7AP to the eighth fixed joint portion 7HP is formed with a rounded-corner rectangular through-hole used in welding. The first fixed joint portion 7AP and the first joint portion 9AP are joined together by welding. However, the first fixed joint portion 7AP and the first joint portion 9AP may be joined together by a conductive adhesive or the like. The same applies to the joining of the second fixed joint portion 7BP and the second joint portion 9BP, the joining of the third fixed joint portion 7CP and the third joint portion 9CP, the joining of the fourth fixed joint portion 7DP and the fourth joint portion 9DP, the joining of the fifth fixed joint portion 7EP and the fifth joint portion 9EP, the joining of the sixth fixed joint portion 7FP and the sixth joint portion 9FP, the joining of the seventh fixed joint portion 7GP and the seventh joint portion 9GP, and the joining of the eighth fixed joint portion 7HP and the eighth joint portion 9HP.

As illustrated in FIG. 7, the first support-side metal member 5G1 is fixed to the support 8 with an adhesive in a state where two rectangular projections 8V formed on the lower surface of the support 8 and projecting downward (Z2 side) are engaged with two rectangular holes formed in the first support-side metal member 5G1. However, the joining between the first support-side metal member 5G1 and the support 8 may be achieved by applying heat caulking or cold caulking to the projections 8V. The same applies to the second support-side metal member 5G2 to the fourth support-side metal member 5G4.

Furthermore, as illustrated in FIG. 7, the first support-side metal member 5G1 is formed with a rounded-corner rectangular through-hole used in welding. The first support-side metal member 5G1 and a ninth embedded metal member 9I are joined together by welding. However, the first support-side metal member 5G1 and the ninth embedded metal member 9I may be joined together by a conductive adhesive or the like. The same applies to the joining of the second support-side metal member 5G2 and the tenth embedded metal member 9J, the joining of the third support-side metal member 5G3 and the eleventh embedded metal member 9K, and the joining of the fourth support-side metal member 5G4 and the twelfth embedded metal member 9L.

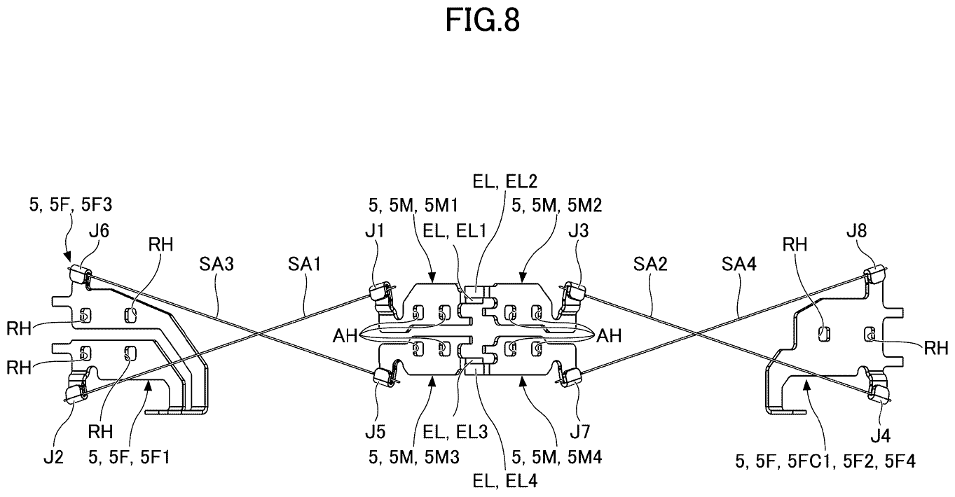

Next, the metal members 5 to which the shape-memory alloy wires SA are attached will be described with reference to FIG. 8. FIG. 8 is a side view of the base-side metal members 5F, the lens-side metal members 5M, and the shape-memory alloy wires SA. Specifically, FIG. 8 is a view of the first base-side metal member 5F1, the third base-side metal member 5F3, the first common base-side metal member 5FC1, the first lens-side metal member 5M1 to the fourth lens-side metal member 5M4, and the first wire SA1 to the fourth wire SA4 as viewed from an oblique front-right side in the direction perpendicular to the optical-axis OA. The positional relationship of each member as illustrated in FIG. 8 corresponds to the positional relationship when the lens drive device 101 is in the neutral state. Although the following description referring to FIG. 8 relates to a combination of the first wire SA1 to the fourth wire SA4, the same can be applied to a combination of the fifth wire SA5 to the eighth wire SA8.

Specifically, one end of the first wire SA1 is fixed to the first lens-side metal member 5M1 at a holding portion J1 of the first lens-side metal member 5M1, and the other end of the first wire SA1 is fixed to the first base-side metal member 5F1 at a holding portion J2 of the first base-side metal member 5F1. Similarly, one end of the second wire SA2 is fixed to the second lens-side metal member 5M2 at a holding portion J3 of the second lens-side metal member 5M2, and the other end of the second wire SA2 is fixed to the first common base-side metal member 5FC1 at a holding portion J4 on the lower side of the first common base-side metal member 5FC1 functioning as the second base-side metal member 5F2. In addition, one end of the third wire SA3 is fixed to the third lens-side metal member 5M3 at a holding portion J5 of the third lens-side metal member 5M3, and the other end of the third wire SA3 is fixed to the third base-side metal member 5F3 at a holding portion J6 of the third base-side metal member 5F3. In addition, one end of the fourth wire SA4 is fixed to the fourth lens-side metal member 5M4 at a holding portion J7 of the fourth lens-side metal member 5M4, and the other end of the fourth wire SA4 is fixed to the first common base-side metal member 5FC1 at a holding portion J8 on the upper side of the first common base-side metal member 5FC1 functioning as the fourth base-side metal member 5F4.

The holding portion J1 is formed by bending a part of the first lens-side metal member 5M1. Specifically, a part of the first lens-side metal member 5M1 is bent in a state of sandwiching one end of the first wire SA1 to form the holding portion J1. Then, one end of the first wire SA1 is fixed to the holding portion J1 by welding. The same applies to the holding portion J2 to the holding portion J8.

As illustrated in FIG. 8, the first wire SA1 and the third wire SA3 are arranged to be skew with respect to each other. In other words, the first wire SA1 and the third wire SA3 are arranged so as not to be in contact (non-contact) with each other. The same applies to the combination of the second wire SA2 and the fourth wire SA4.

The base member 3 is configured to function as a wire support member for supporting the other ends of the first wire SA1 to the eighth wire SA8. With this configuration, the lens holder 2 is supported by the base member 3 in a state movable in the optical-axis direction (Z-axis direction) which is a direction parallel to the optical-axis OA through the first wire SA1 to the eighth wire SA8.

The lens-side metal members 5M include extended portions EL configured to extend in a circumferential direction (tangential direction) of a circle centering on the optical-axis OA. Specifically, the first lens-side metal member 5M1 includes a first extended portion EL1, the second lens-side metal member 5M2 includes a second extended portion EL2, the third lens-side metal member 5M3 includes a third extended portion EL3, and the fourth lens-side metal member 5M4 includes a fourth extended portion EL4.

In the illustrated example, the first lens-side metal member 5M1 and the second lens-side metal member 5M2 are arranged such that the second extended portion EL2 is located outside the first extended portion EL1 (farther from the optical-axis OA), and the first extended portion EL1 and the second extended portion EL2 are joined together by a conductive adhesive. Similarly, the third lens-side metal member 5M3 and the fourth lens-side metal member 5M4 are arranged such that the fourth extended portion EL4 is located outside the third extended portion EL3, and the third extended portion EL3 and the fourth extended portion EL4 are joined together by a conductive adhesive. The joining of the extended portions EL to each other may be achieved by welding, soldering, or the like. The extended portions EL may be arranged such that they do not overlap with each other in the radial direction, that is, they are adjacent in the optical-axis direction.

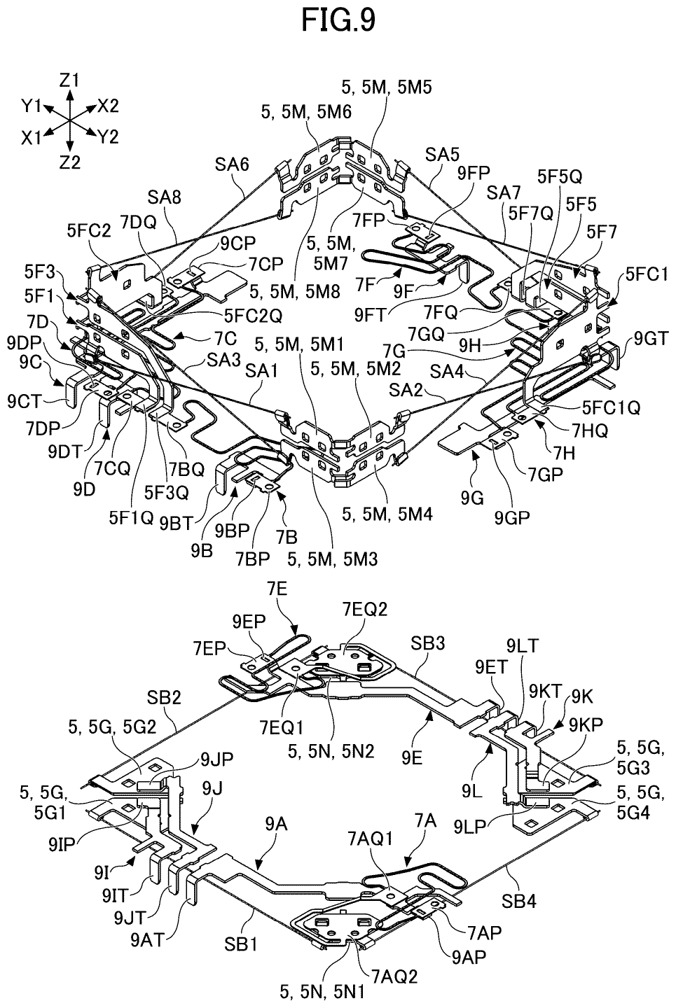

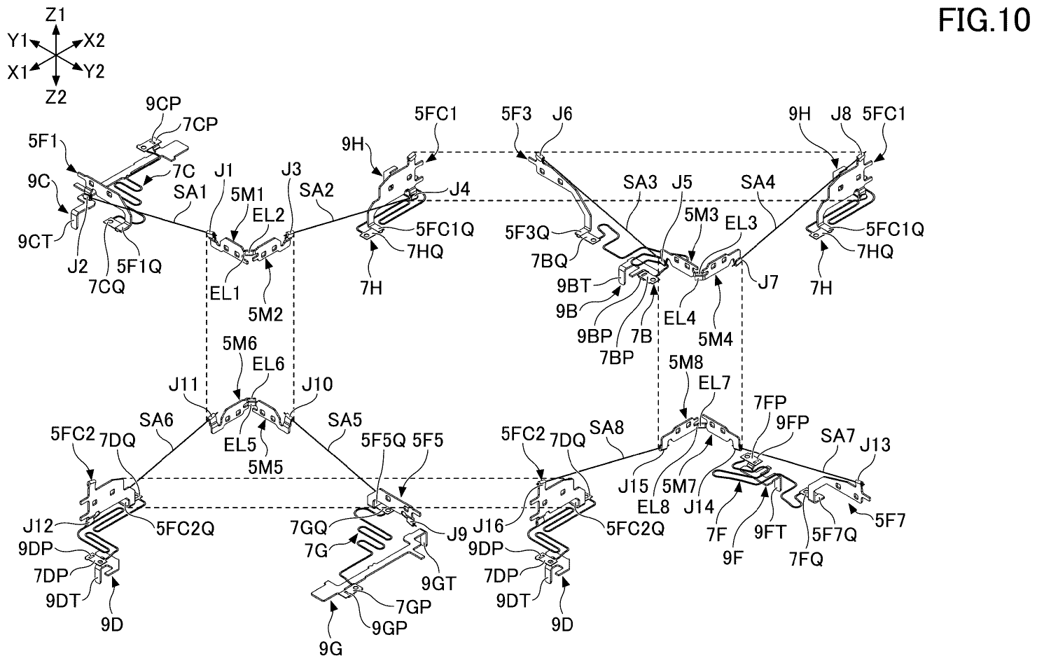

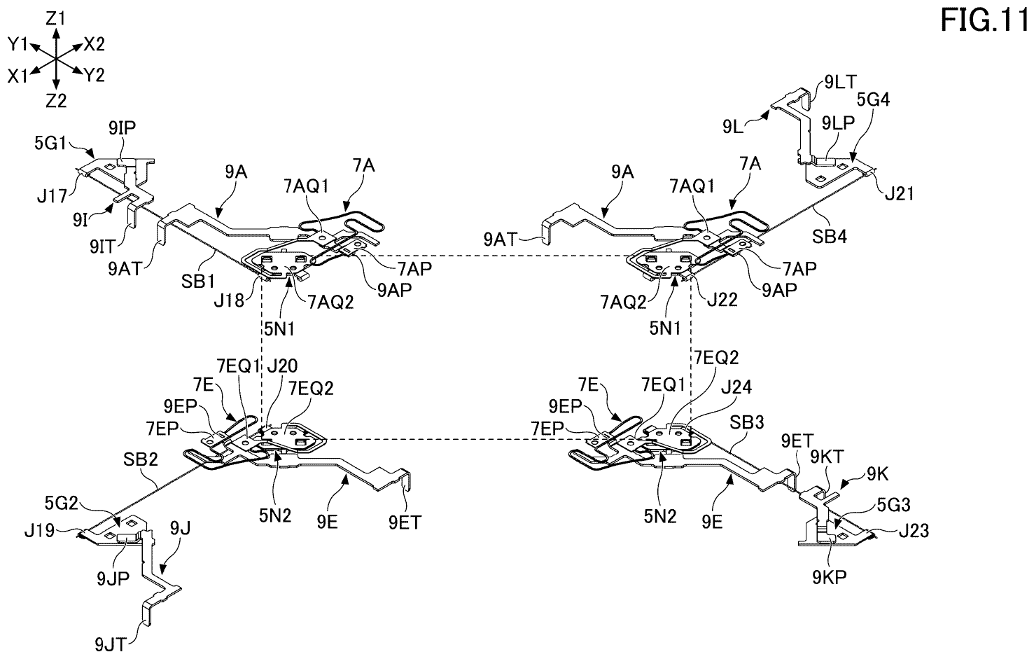

Next, referring to FIGS. 9, 10, and 11, a positional relationship of the metal member 5, the flexible metal member 7, the embedded metal members 9, the shape-memory alloy wires SA, and the shape-memory alloy wires SB, which are the members through which current flows, will be described. FIG. 9 is perspective views of the metal member 5, the flexible metal member 7, the embedded metal members 9, the shape-memory alloy wires SA, and the shape-memory alloy wires SB. Specifically, the upper figure of FIG. 9 is a perspective view of the members related to the energization path including the shape-memory alloy wires SA, and the lower figure of FIG. 9 is a perspective view of the members related to the energization path including the shape-memory alloy wires SB. FIG. 10 is views partially taken out of the upper figure of FIG. 9. The upper-left figure of FIG. 10 illustrates members associated with an energization path including the first wire SA1 and the second wire SA2. The upper-right figure of FIG. 10 illustrates members associated with the energizing path including the third wire SA3 and the fourth wire SA4. The lower-left figure of FIG. 10 illustrates members associated with the energizing path including the fifth wire SA5 and the sixth wire SA6. The lower-right figure of FIG. 10 illustrates members associated with the energizing path including the seventh wire SA7 and the eighth wire SA8. In addition, FIG. 11 is views partially extracted from the lower figure of FIG. 9. The upper-left figure of FIG. 11 illustrates members associated with the current passage including the first wire SB1. The lower-left figure of FIG. 11 illustrates members associated with the current passage including the second wire SB2. The lower-right figure of FIG. 11 illustrates members associated with the current passage including the third wire SB3. The upper-right figure of FIG. 11 illustrates members associated with the current passage including the fourth wire SB4.

As illustrated in the upper-left figure of FIG. 10, when a third terminal 9CT of the third embedded metal member 9C is connected to a high potential and the eighth terminal 9HT (see FIG. 2) of the eighth embedded metal member 9H is connected to a low potential, the current flows from the third terminal 9CT of the third embedded metal member 9C to the eighth terminal 9HT of the eighth embedded metal member 9H through the third joint portion 9CP of the third embedded metal member 9C, the third flexible metal member 7C (the third fixed joint portion 7CP and the third movable joint portion 7CQ), the first base-side metal member 5F1 (a joint portion 5F1Q and the holding portion J2), the first wire SA1, the first lens-side metal member 5M1 (the holding portion J1 and the first extended portion EL1), the second lens-side metal member 5M2 (the second extended portion EL2 and the holding portion J3), the second wire SA2, the first common base-side metal member 5FC1 (the holding portion J4 and a joint portion 5FC1Q), the eighth flexible metal member 7H (the eighth movable joint portion 7HQ and the eighth fixed joint portion 7HP (see FIG. 2)), and the eighth joint portion 9HP (see FIG. 2) of the eighth embedded metal member 9H.

As illustrated in the upper-right figure of FIG. 10, when the second terminal 9BT of the second embedded metal member 9B is connected to a high potential and the eighth terminal 9HT of the eighth embedded metal member 9H (see FIG. 2) is connected to a low potential, the current flows from the second terminal 9BT of the second embedded metal member 9B to the eighth terminal 9HT of the eighth embedded metal member 9H, through the second joint portion 9BP of the second embedded metal member 9B, the second flexible metal member 7B (the second fixed joint portion 7BP and the second movable joint portion 7BQ), the third base-side metal member 5F3 (a joint portion 5F3Q and the holding portion J6), the third wire SA3, the third lens-side metal member 5M3 (the holding portion J5 and the third extended portion EL3), the fourth lens-side metal member 5M4 (the fourth extended portion EL4 and the holding portion J7), the fourth wire SA4, the first common base-side metal member 5FC1 (the holding portion J8 and the joint portion 5FC1Q), the eighth flexible metal member 7H (the eighth movable joint portion 7HQ and the eighth fixed joint portion 7HP (see FIG. 2)), and the eighth joint portion 9HP of the eighth embedded metal member 9H (see FIG. 2).

In both cases where the third terminal 9CT of the third embedded metal member 9C is connected to a high potential and when the second terminal 9BT of the second embedded metal member 9B is connected to a high potential, the path of the current flowing from the first common base-side metal member 5FC1 to the eighth terminal 9HT of the eighth embedded metal member 9H is the same.

Furthermore, as illustrated in the lower-left figure of FIG. 10, when the seventh terminal 9GT of a seventh embedded metal member 9G is connected to a high potential and the fourth terminal 9DT of a fourth embedded metal member 9D is connected to a low potential, the current flows from the seventh terminal 9GT of the seventh embedded metal member 9G to the fourth terminal 9DT of the fourth embedded metal member 9D through a seventh joint portion 9GP of the seventh embedded metal member 9G, a seventh flexible metal member 7G (the seventh fixed joint portion 7GP and the seventh movable joint portion 7GQ), the fifth base-side metal member 5F5 (a joint portion 5F5Q and a holding portion J9), the fifth wire SA5, the fifth lens-side metal member 5M5 (a holding portion J10 and a fifth extended portion EL5), the sixth lens-side metal member 5M6 (a sixth extended portion EL6 and a holding portion J11), the sixth wire SA6, the second common base-side metal member 5FC2 (a holding portion J12 and a joint portion 5FC2Q), the fourth flexible metal member 7D (fourth movable joint portion 7DQ and fourth fixed joint portion 7DP), and the fourth joint portion 9DP of the fourth embedded metal member 9D.

When the sixth terminal 9FT of the sixth embedded metal member 9F is connected to a high potential and the fourth terminal 9DT of the fourth embedded metal member 9D is connected to a low potential as illustrated in the lower-right figure of FIG. 10, the current flows from the sixth terminal 9FT of the sixth embedded metal member 9F to the fourth terminal 9DT of the fourth embedded metal member 9D through the sixth joint portion 9FP of the sixth embedded metal member 9F, the sixth flexible metal member 7F (the sixth fixed joint portion 7FP and the sixth movable joint portion 7FQ), the seventh base-side metal member 5F7 (a joint portion 5F7Q and a holding portion J13), the seventh wire SA7, the seventh lens-side metal member 5M7 (a holding portion J14 and a seventh extended portion EL7), the eighth lens-side metal member 5M8 (an eighth extended portion EL8 and a holding portion J15), the eighth wire SA8, the second common base-side metal member 5FC2 (a holding portion J16 and the joint portion 5FC2Q), the fourth flexible metal member 7D (the fourth movable joint portion 7DQ and the fourth fixed joint portion 7DP), and the fourth joint portion 9DP of the fourth embedded metal member 9D.

In both cases where the sixth terminal 9FT of the sixth embedded metal member 9F is connected to a high potential and when the seventh terminal 9GT of the seventh embedded metal member 9G is connected to a high potential, the path of the current flowing from the second common base-side metal member 5FC2 to the fourth terminal 9DT of the fourth embedded metal member 9D is the same.

When the ninth terminal 9IT of the ninth embedded metal member 9I is connected to a high potential and the first terminal 9AT of the first embedded metal member 9A is connected to a low potential as illustrated in the upper-left figure of FIG. 11, the current flows from the ninth terminal 9IT of the ninth embedded metal member 9I to the first terminal 9AT of the first embedded metal member 9A through the ninth joint portion 9IP of the ninth embedded metal member 9I, the first support-side metal member 5G1 (a holding portion J17), the first wire SB1, the first supported-side metal member 5N1 (a holding portion J18), the first flexible metal member 7A (the first outer movable joint portion 7AQ2, the first inner movable joint portion 7AQ1, and the first fixed joint portion 7AP), and the first joint portion 9AP of the first embedded metal member 9A.

Furthermore, as illustrated in the upper-right figure of FIG. 11, when the twelfth terminal 9LT of the twelfth embedded metal member 9L is connected to a high potential and the first terminal 9AT of the first embedded metal member 9A is connected to a low potential, the current flows from the twelfth terminal 9LT of the twelfth embedded metal member 9L to the first terminal 9AT of the first embedded metal member 9A through the twelfth joint portion 9LP of the twelfth embedded metal member 9L, the fourth support-side metal member 5G4 (a holding portion J21), the fourth wire SB4, the first supported-side metal member 5N1 (a holding portion J22), the first flexible metal member 7A (the first outer movable joint portion 7AQ2, the first inner movable joint portion 7AQ1, and the first fixed joint portion 7AP), and the first joint portion 9AP of the first embedded metal member 9A.

In both cases where the ninth terminal 9IT of the ninth embedded metal member 9I is connected to a high potential and where the twelfth terminal 9LT of the twelfth embedded metal member 9L is connected to a high potential, the path of the current flowing from the first supported-side metal member 5N1 to the first terminal 9AT of the first embedded metal member 9A is the same.

When the tenth terminal 9JT of the tenth embedded metal member 9J is connected to a high potential and the fifth terminal 9ET of the fifth embedded metal member 9E is connected to a low potential, the current flows from the tenth terminal 9JT of the tenth embedded metal member 9J to the fifth terminal 9ET of the fifth embedded metal member 9E through the tenth joint portion 9JP of the tenth embedded metal member 9J, the second support-side metal member 5G2 (a holding portion J19) 11, the second wire SB2, the second supported-side metal member 5N2 (a holding portion J20), the fifth flexible metal member 7E (the fifth outer movable joint portion 7EQ2, the fifth inner movable joint portion 7EQ1, and the fifth fixed joint portion 7EP), and the fifth joint portion 9EP of the fifth embedded metal member 9E.

When the eleventh terminal 9KT of the eleventh embedded metal member 9K is connected to a high potential and the fifth terminal 9ET of the fifth embedded metal member 9E is connected to a low potential, the current flows from the eleventh terminal 9KT of the eleventh embedded metal member 9K to the fifth terminal 9ET of the fifth embedded metal member 9E through the eleventh joint portion 9KP of the eleventh embedded metal member 9K, the third support-side metal member 5G3 (a holding portion J23), the third wire SB3, the second supported-side metal member 5N2 (a holding portion J24), the fifth flexible metal member 7E (the fifth outer movable joint portion 7EQ2, the fifth inner movable joint portion 7EQ1, and the fifth fixed joint portion 7EP), and the fifth joint portion 9EP of the fifth embedded metal member 9E.

In both cases where the tenth terminal 9JT of the tenth embedded metal member 9J is connected to a high potential and the eleventh terminal 9KT of the eleventh embedded metal member 9K is connected to a high potential, the path of the current flowing from the second supported-side metal member 5N2 to the fifth terminal 9ET of the fifth embedded metal member 9E is the same.

The controller located outside the lens drive device 101 as described above can control lengths of the shape-memory alloy wires SA (the first wire SA1 to the eighth wire SA8) and lengths of the shape-memory alloy wires SB (the first wire SB1 to the fourth wire SB4) by controlling voltages applied to the respective terminals (the first terminal 9AT to the twelfth terminal 9LT) of the first embedded metal member 9A to the twelfth embedded metal member 9L. For example, the controller may detect the respective electrical resistance values of the shape-memory alloy wires and control the respective lengths of the shape-memory alloy wires according to the detection result. The controller may be disposed in the lens drive device 101. The controller may be a component of the lens drive device 101.

For example, the controller may move the lens holder 2 in the direction parallel to the optical-axis OA (Z-axis direction) on the Z1-side (subject side) of the image sensor IS by using a driving force in the direction parallel to the optical-axis OA due to the contraction of the shape-memory alloy wires SA as the first driver DM1. By moving the lens holder 2 in this way, the controller may achieve an automatic focusing function, which is one of lens adjustment functions. Specifically, the controller may move the lens holder 2 in a direction away from the image sensor to enable macro photographing, and may move the lens holder 2 in a direction toward the image sensor to enable infinity focus photographing.

Furthermore, the controller may move the lens holder 2 together with the base member 3 in directions crossing the optical-axis OA (relative to the X-axis direction and the Y-axis direction, respectively) by controlling the current flowing through the shape-memory alloy wires SB as the second driver DM2. Thus, the controller may achieve an optical-image stabilization function.

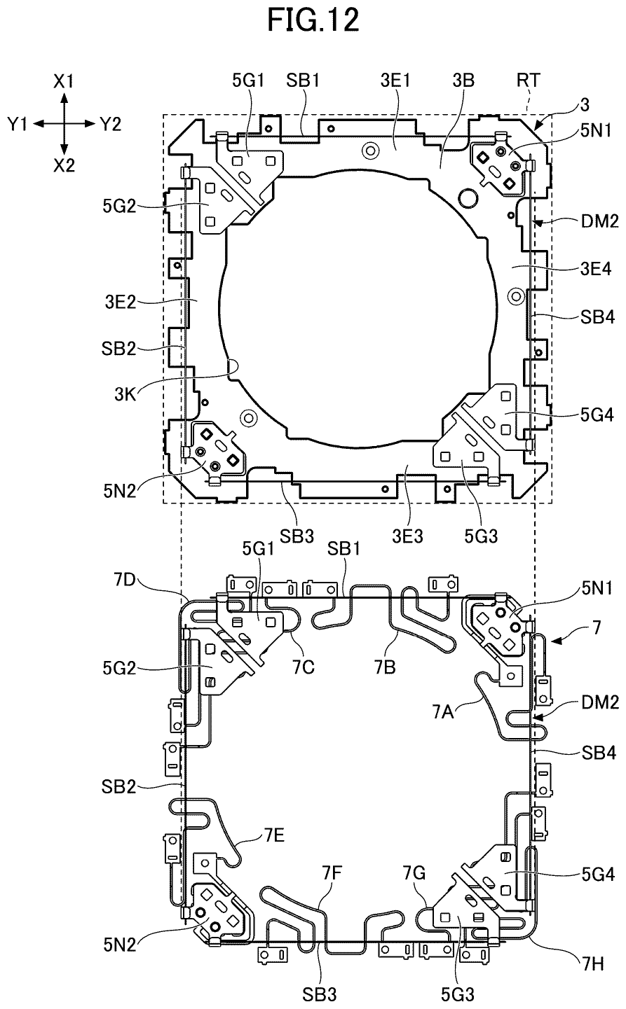

Next, a positional relationship between the second driver DM2, the base member 3, and the flexible metal member 7 will be described with reference to FIG. 12. FIG. 12 is a bottom view of the base member 3, the flexible metal member 7, and the second driver DM2. Specifically, the upper figure of FIG. 12 is a bottom view of the base member 3 and the second driver DM2, and the lower figure of FIG. 12 is a bottom view of the flexible metal member 7 and the second driver DM2. The second driver DM2 includes the first wire SB1 to the fourth wire SB4, the first support-side metal member 5G1 to the fourth support-side metal member 5G4, the first supported-side metal member 5N1, and the second supported-side metal member 5N2.

As illustrated in the upper figure of FIG. 12, when viewed in the optical-axis direction, the second driver DM2 is configured to be positioned inside a square RT represented by a broken line surrounding the base member 3 when the lens drive device 101 is in the neutral state.

Also, as illustrated in the lower figure of FIG. 12, when viewed in the optical-axis direction, the second driver DM2 is configured to be partially overlapped with the flexible metal member 7 across the support 8 (not illustrated in the lower figure of FIG. 12). Specifically, the first wire SB1 is arranged to overlap with the first flexible metal members 7A to 7D, the second wire SB2 is arranged to overlap with the third flexible metal members 7C to 7E, the third wire SB3 is arranged to overlap with the fifth flexible metal members 7E to 7H, and the fourth wire SB4 is arranged to overlap with the first flexible metal member 7A, the seventh flexible metal member 7G, and the eighth flexible metal member 7H.

This configuration has the effect that, when viewed in the optical-axis direction, the size of the lens drive device 101 can be reduced as compared with a case where each of the shape-memory alloy wires SB (the first wire SB1 to the fourth wire SB4) is located outside the square RT.

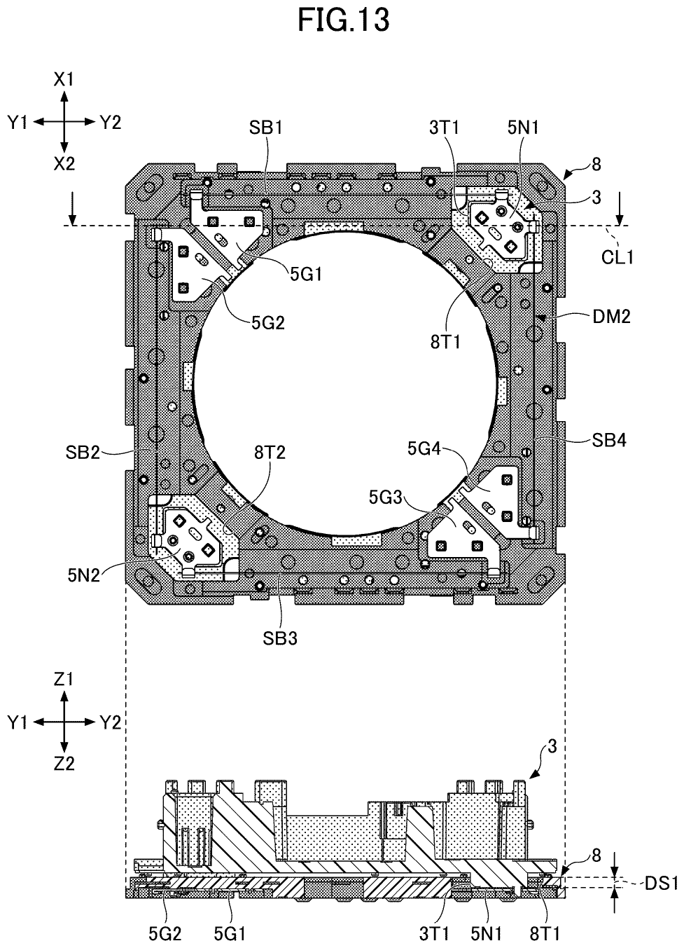

Next, with reference to FIG. 13, a positional relationship between the second driver DM2, the base member 3, and the support 8 will be described. FIG. 13 is a figure illustrating the positional relationship between the base member 3, the support 8, and the second driver DM2. Specifically, the upper figure of FIG. 13 is a bottom view of the base member 3, the support 8, and the second driver DM2, and the lower figure of FIG. 13 is a cross-sectional view of the base member 3, the support 8, and the second driver DM2. Specifically, the lower figure of FIG. 13 is a cross-sectional view of the base member 3, the support 8, and the second driver DM2 in a YZ-plane including a cut line CL1 in the upper figure of FIG. 13 as viewed from the X1 side.

As illustrated in the lower figure of FIG. 13, in the neutral state of the lens drive device 101, the base member 3 is configured such that the lower-end surface of the projection 3T (the first projection 3T1) projects from the upper surface of the support 8 through a through-opening 8T (first through-opening 8T1), within a range of a distance DS1. In this way, on the lower side of the support 8, the position (height) of the supported-side metal member 5N (the first supported-side metal member 5N1) and the position (height) of the support-side metal members 5G (the first supported-side metal member 5G1 and the second supported-side metal member 5G2) in the optical-axis direction (Z-axis direction) can be made the same.

This configuration can achieve the lens drive device 101 including the second driver DM2 (the shape-memory alloy wires SB) disposed on a lower-surface side of the support 8 by simply providing the projections 3T on the base member 3 and the through-openings 8T on the support 8. Specifically, this configuration provides an effect that the supported-side metal members 5N included in the second driver DM2 can be assembled to the base member 3 and the support-side metal members 5G included in the second driver DM2 can be assembled to the support 8 with a simple structure.

As described above, the lens drive device 101 according to the embodiment of the present disclosure includes, as illustrated in FIG. 2, the base member 3, the lens holder 2 including the cylindrical portion 2C capable of holding the lens body LS and movable relative to the base member 3, and the driver (first driver DM1) which is provided between the base member 3 and the lens holder 2 and including the plurality of shape-memory alloy wires SA which move the lens holder 2 in the vertical direction at least in the optical-axis direction. The shape-memory alloy wires SA include the first wire SA1 and the third wire SA3 which cross each other in a side view (front view) as viewed from the first direction (X-axis direction) orthogonal to the optical-axis OA, and the second wire SA2 and the fourth wire SA4 which cross each other in a side view (right-side view) as viewed from the second direction (Y-axis direction) orthogonal to the optical-axis OA and perpendicular to the first direction (X-axis direction). Each of the first wire SA1, the second wire SA2, the third wire SA3 and the fourth wire SA4 has one end fixed to a corresponding lens-side metal member 5M provided (fixed) on the outer peripheral surface of the lens holder 2, the other end fixed to a corresponding base-side metal member 5F provided (fixed) on the base member 3, and is configured such that each wire within a range between one end and the other end becomes straight when energized. Each of the first wire SA1 and the second wire SA2 is arranged such that the position of one end is on the subject side that is above the position of the other end in the optical-axis direction, and each of the third wire SA3 and the fourth wire SA4 is arranged such that the position of the other end is on the subject side that is above the position of the other end in the optical-axis direction. The lens-side metal members 5M include a first lens-side metal member 5M1 to which one end of the first wire SA1 is fixed, a second lens-side metal member 5M2 to which one end of the second wire is fixed, a third lens-side metal member 5M3 to which one end of the third wire SA3 is fixed, and a fourth lens-side metal member 5M4 to which one end of the fourth wire SA4 is fixed. The first lens-side metal member 5M1 and the second lens-side metal member 5M2 are electrically connected, and the first wire SA1 and the second wire SA2 are connected in series. That is, the first wire SA1 and the second wire SA2 are configured to be in series (to form a series circuit). Similarly, the third lens-side metal member 5M3 and the fourth lens-side metal member 5M4 are electrically connected, and the third wire SA3 and the fourth wire SA4 are connected in series. The first lens-side metal member 5M1 and the third lens-side metal member 5M3 are arranged on the first side surface LF1 of the lens holder 2 separately and adjacent to each other, and the second lens-side metal member 5M2 and the fourth lens-side metal member 5M4 are arranged on the second side surface LF2 of the lens holder 2 separately and adjacent to each other. That is, the first lens-side metal member 5M1 and the third lens-side metal member 5M3 are insulated from each other when the shape-memory alloy wire is not present, and the second lens-side metal member 5M2 and the fourth lens-side metal member 5M4 are insulated from each other when the shape-memory alloy wire is not present. In the illustrated example, one end of the first wire SA1 and one end of the second wire SA2 are adjacent to each other. That is, a distance between one end of the first wire SA1 and one end of the second wire SA2 is smaller than a distance between the other end of the first wire SA1 and the other end of the second wire SA2. The same applies to the relationship between the third wire SA3 and the fourth wire SA4.

This configuration has the effect of suppressing the occurrence of issues related to the holding of the shape-memory alloy wires SA. This is because the shape-memory alloy wires SA are configured such that each wire within a range between one end and the other end becomes straight when energized, and the intermediate portion is not hooked to other components. Therefore, this configuration can suppress the occurrence of issues such as that the intermediate portion of the shape-memory alloy wire slides on other components to cause abrasion powder, scraping, or rubbing, or that the intermediate portion of the shape-memory alloy wire comes off from the holding element. Therefore, this configuration can suppress the occurrence of effects on the subsequent operation of the lens drive device 101 even when a strong shock due to dropping or the like is applied to the lens drive device 101.

The lens holder 2 includes the corner portion 2D (the first corner portion 2D1), and the first side surface LF1 and the second side surface LF2 may be adjacent to each other in the circumferential direction, across the first corner portion 2D1. In the illustrated example, the corner portion 2D (first corner portion 2D1) is configured such that a plane along the first side surface LF1 and a plane along the second side surface LF2 are perpendicular to each other.

In this configuration, since the first side surface LF1 and the second side surface LF2 are arranged close to each other, the conductivity of the corresponding lens-side metal members 5M is enhanced as compared to a case where the first side surface LF1 and the second side surface LF2 are arranged further apart from each other.

Furthermore, the first lens-side metal member 5M1 and the third lens-side metal member 5M3 may be arranged separately and adjacent to each other in the optical-axis direction. Similarly, the second lens-side metal member 5M2 and the fourth lens-side metal member 5M4 may be arranged separately and adjacent to each other in the optical-axis direction. In this case, as illustrated in FIG. 8, each of the first lens-side metal member 5M1 and the second lens-side metal member 5M2 may include an extended portion EL. Among the two extended portions EL, one extended portion EL is located outside the other in the radial direction of the circle centered on the optical-axis OA, and the two extended portions EL may be joined together at the extended portions EL. Similarly, each of the third lens-side metal member 5M3 and the fourth lens-side metal member 5M4 may include an extended portion EL. Among the two extended portions EL, one extended portion EL is located outside the other in the radial direction of the circle centered on the optical-axis OA, and the two extended portions EL may be joined together at the extended portion EL. Note that the first extended portion EL1 of the first lens-side metal member 5M1 and the second extended portion EL2 of the second lens-side metal member 5M2 may be arranged to contact each other. Also, the third extended portion EL3 of the third lens-side metal member 5M3 and the fourth extended portion EL4 of the fourth lens-side metal member 5M4 may be arranged to contact each other.

This configuration has the effect that the corresponding lens-side metal member 5M are more readily connected to each other than the configuration without the extended portion EL.

Each of the corner portions 2D may include a corner surface CF as illustrated in FIG. 2. In this case, each of the first lens-side metal member 5M1, the second lens-side metal member 5M2, the third lens-side metal member 5M3, and the fourth lens-side metal member 5M4 may include an extended portion EL extending along the corner surface CF, and a corresponding pair of the extended portions EL may be joined together as illustrated in FIG. 8. In the illustrated example, the first corner portion 2D1 includes a first corner side-surface CF1, and the second corner portion 2D2 includes a second corner side-surface CF2. Each of the first extended portion EL1 to the fourth extended portion EL4 is arranged to extend along the first corner side-surface CF1, and each of the fifth extended portion EL5 to the eighth extended portion EL8 is arranged to extend along the second corner side-surface CF2. Note that the corner surface CF may be a curved surface instead of a flat surface.

In this configuration, since the two extended portions EL to be joined together are arranged along the corner surface CF as a common surface, joining of the corresponding pair of extended portions EL becomes simple as compared to a case where two extended portions EL to be joined together are arranged on different surfaces. Therefore, this configuration enhances the assemblability of the lens drive device 101 and, consequently, the productivity of the lens drive device 101.

In addition, the corresponding pair of extended portions EL may be joined together by welding. This configuration has the effect of facilitating the joining of the corresponding pair of extended portions EL.

The base-side metal members 5F may include the first base-side metal member 5F1 to which the other end of the first wire SA1 is fixed, the second base-side metal member 5F2 to which the other end of the second wire SA2 is fixed, the third base-side metal member 5F3 to which the other end of the third wire SA3 is fixed, and the fourth base-side metal member 5F4 to which the other end of the fourth wire SA4 is fixed. In this case, the first base-side metal member 5F1 and the third base-side metal member 5F3 may be fixed to the first side surface SF1 of the base member 3 separately and adjacent to each other, and the second base-side metal member 5F2 and the fourth base-side metal member 5F4 may be integrated as the common base-side metal member 5FC (first common base-side metal member 5FC1) and fixed to the second side surface SF2 of the base member 3.

This configuration has the effect that the number of components can be reduced as compared with a case where the second base-side metal member 5F2 and the fourth base-side metal member 5F4 are separately provided as independent components.

The first wire SA1, the third wire SA3, the first lens-side metal member 5M1, the third lens-side metal member 5M3, the first base-side metal member 5F1, and the third base-side metal member 5F3 may each be doubly provided to form a pair between which the optical-axis (the cylindrical portion 2C) is interposed. In the illustrated example, the fifth wire SA5, the seventh wire SA7, the fifth lens-side metal member 5M5, the seventh lens-side metal member 5M7, the fifth base-side metal member 5F5, and the seventh base-side metal member 5F7 correspond to the first wire SA1, the third wire SA3, the first lens-side metal member 5M1, the third lens-side metal member 5M3, the first base-side metal member 5F1, and the third base-side metal member 5F3, respectively. Similarly, the second wire SA2, the fourth wire SA4, the second lens-side metal member 5M2, the fourth lens-side metal member 5M4, and the common base-side metal member 5FC (first common base-side metal member 5FC1) may each be doubly provided to form a pair between which the optical-axis (the cylindrical portion 2C) is interposed. In the illustrated example, the sixth wire SA6, the eighth wire SA8, the sixth lens-side metal member 5M6, the eighth lens-side metal member 5M8, and the second common base-side metal member 5FC2 correspond to the second wire SA2, the fourth wire SA4, the second lens-side metal member 5M2, the fourth lens-side metal member 5M4, and the first common base-side metal member 5FC1, respectively.

This configuration has the effect that the movement of the lens holder 2 in the optical-axis direction is stabilized as compared with a case where the first driver DM1 is arranged at a biased position around the optical-axis OA.

Furthermore, the lens drive device 101 may include the support 8 (the fixed-side member FB) arranged below the base member 3, and another driver (the second driver DM2) for moving the base member 3 in a direction crossing the optical-axis direction.

This configuration has the effect that the optical-image stabilization function can be achieved in addition to the automatic focusing function.

Furthermore, as illustrated in FIG. 2, the lens drive device 101 according to the embodiment of the present disclosure is provided with the fixed-side member FB including the support 8, the base member 3 supported by the support 8, the lens holder 2 including the cylindrical portion 2C capable of holding the lens body LS and movable relative to the base member 3 at least in the optical-axis direction, the first driver DM1 for moving the lens holder 2 relative to the base member 3 at least in the optical-axis direction, and the second driver DM2 including a plurality of shape-memory alloy wires SB for moving the base member 3 relative to the support 8 in the direction crossing the optical-axis direction. The base member 3 and the lens holder 2 are arranged on the upper surface side of the support 8 (the base 8B) in the vertical direction (Z-axis direction) of the optical-axis. The base member 3 includes the body 3B arranged on the upper surface side of the support 8 (the base 8B) and the projections 3T (see FIG. 4) projecting below the upper surface of the support 8 (the base 8B). The shape-memory alloy wires SB are provided between the fixed-side member FB and the projections 3T and are arranged to face the lower surface of the support 8 (the base 8B).

This configuration has the effect of suppressing the occurrence of issues related to entanglement of the shape-memory alloy wires SB. The shape-memory alloy wires SB are provided on the lower-surface side of the support 8, and thus contact with the movable-side member MB (the base member 3) or the like provided on the upper surface side of the support 8 can be avoided. As a result, this configuration enhances free arrangement of the components. That is, this configuration has the effect of suppressing entanglement between the shape-memory alloy wires SB and other components when the shape-memory alloy wires SB are undesirably deformed. Therefore, this configuration reduces the distance between the shape-memory alloy wires SB and other components, and consequently, enhances free designing of the lens drive device 101.

Furthermore, as illustrated in FIG. 2, the support 8 may include the through-openings 8T (the through-openings 8T through which the projections 3T are at least partially inserted) in which the projections 3T of the base member 3 are disposed. In the illustrated example, the support 8 includes the first through-opening 8T1 in which the first projection 3T1 is disposed and a second through-opening 8T2 in which the second projection 3T2 is disposed. The lower end surfaces of the projections 3T need not necessarily be located below the lower surface of the base 8B of the support 8.

This configuration has the effect that the lens drive device 101 including the second driver DM2 (the shape-memory alloy wires SB) disposed on the lower-surface side of the support 8 can be achieved by a simple structure. Specifically, this configuration has the effect that the supported-side metal members 5N included in the second driver DM2 can be assembled to the base member 3 by a simple structure.

Furthermore, as illustrated in FIG. 2, the support 8 (the base 8B) may include an opening 8K through which light passing through the lens body LS can pass. In this case, the support 8 (the base 8B) may include partitions 8S located between the through-openings 8T and the opening 8K. In the illustrated example, the support 8 includes a first partition 8S1 located between the opening 8K and the first through-opening 8T1, and a second partition 8S2 located between the opening 8K and the second through-opening 8T2.

This configuration has the effect that the strength of the support 8 can be increased as compared with a case where the opening 8K and the through-openings 8T are continuous.

The partitions 8S may also include the embedded metal members 9. In the illustrated example, the first partition 8S1 includes a wide portion 9AU of the first embedded metal member 9A, and the second partition 8S2 includes a wide portion 9EU of the fifth embedded metal member 9E.

This configuration has the effect that the strength of the support 8 can be further increased. This configuration also enhances free designing of the embedded metal members 9 functioning as a part of the energization path.

As illustrated in the upper figure of FIG. 12, the shape-memory alloy wires SB may be located inside the square RT surrounding the base member 3 when viewed in the optical-axis direction. Specifically, the base member 3 (the body 3B) may include the first side portion 3E1 and the third side portion 3E3 facing each other in the first direction (X-axis direction) perpendicular to the optical-axis direction with the opening 3K therebetween, and the second side portion 3E2 and the fourth side portion 3E4 facing each other in the second direction (Y-axis direction) perpendicular to the optical-axis direction with the opening 3K therebetween. The shape-memory alloy wires SB (the first wire SB1 to the fourth wire SB4) may be located inside straight lines (sides of the square RT represented by a broken line) along the outer edges of the first side portion 3E1 to the fourth side portion 3E4 when viewed in the optical-axis direction.

This configuration has the effect that the size of the lens drive device 101 can be reduced as compared with a case where each of the shape-memory alloy wires SB (the first wire SB1 to the fourth wire SB4) is located outside the square RT when viewed in the optical-axis direction.

Furthermore, as illustrated in FIG. 2, the support-side metal members 5G may be provided on the lower surface of the support 8, and the supported-side metal members 5N may be provided on the projections 3T of the base member 3. In this case, the support-side metal members 5G include the first support-side metal member 5G1, the second support-side metal member 5G2, the third support-side metal member 5G3, and the fourth support-side metal member 5G4, the supported-side metal members 5N include the first supported-side metal member 5N1 and the second supported-side metal member 5N2, and the shape-memory alloy wires SB may include the first wire SB1, the second wire SB2, the third wire SB3, and the fourth wire SB4. The first wire SB1 may include one end fixed to the first supported-side metal member 5N1 and the other end fixed to the first support-side metal member 5G1, the second wire SB2 may include one end fixed to the second supported-side metal member 5N2 and the other end fixed to the second support-side metal member 5G2, the third wire SB3 may include one end fixed to the second supported-side metal member 5N2 and the other end fixed to the third support-side metal member 5G3, and the fourth wire SB4 may include one end fixed to the first supported-side metal member 5N1 and the other end fixed to the fourth support-side metal member 5G4. In the illustrated example, the supported-side metal members 5N are fixed to the projections 3T of the base member 3 via the flexible metal member 7, but may be fixed to a metal embedded in the base member 3.

This configuration has the effect that an energization path including the shape-memory alloy wires SB can be achieved with a simple structure. This is because the supported-side metal members 5N to which one end of each of the shape-memory alloy wires SB is fixed function as a part of the energization path. As a result, this configuration has the effect that the shape-memory alloy wires SB can be securely arranged at desired positions.

Furthermore, the support 8 may include the embedded metal members 9 which are embedded in a state partially exposed as exposed parts EX (see FIG. 6) on the upper surface of the support 8. In this case, as illustrated in FIG. 5, the base member 3 may include a plurality of contact portions 3C (guided parts GE) which project downward from the body 3B and whose tips contact guides GD which are a part of the exposed parts EX of the embedded metal members 9. In the illustrated example, the exposed parts EX are included in the first embedded metal member 9A, the fifth embedded metal member 9E, and the seventh embedded metal member 9G as illustrated in FIG. 5. The guided parts GE include a first guided part GE1 which contacts a first guide GD1 which is a part of the exposed parts EX of the first embedded metal member 9A, a second guided part GE2 which contacts a second guide GD2 which is a part of the exposed parts EX of the fifth embedded metal member 9E, and a third guided part GE3 which contacts a third guide GD3 which is a part of the exposed parts EX of the seventh embedded metal member 9G.

This configuration has the effect that the embedded metal members 9 can be used as the guides GD when the base member 3 is moved in the direction perpendicular to the optical-axis direction. That is, this configuration has the effect that the embedded metal members 9, which are less deformed than when made of the synthetic resin, can be used as the guides GD. In addition, when the metal (the embedded metal members 9) and the synthetic resin (the base member 3) slide against each other, the synthetic resin is less shaved as compared to a case when the sliding members are both synthetic resins. Therefore, this configuration has the effect that generation of wear debris can be suppressed.

The fixed-side member FB may include a magnetic member 10 as illustrated in FIG. 2. In this case, the base member 3 may be provided with a plurality of magnets 4 (the first magnet 41 and the second magnet 42). The exposed parts EX and the contact portions 3C as illustrated in FIG. 5 may be configured to press each other by the attraction force acting between the magnets 4 and the magnetic member 10. In the illustrated example, the magnetic member 10 is a shield plate adhered and fixed to the lower side of the support 8, but it may be a magnetic metal member embedded in the support 8.

This configuration has the effect that the base member 3 can be prevented from being separated from the support 8 (floating up). That is, this configuration has the effect that the contact between the base member 3 and the embedded metal members 9 embedded in the support 8 can be ensured.

Furthermore, as illustrated in FIG. 2, between the support 8 (the base 8B) and the base member 3 (the body 3B), the flexible metal member 7 for energization may be provided which is electrically connected to at least one of the first driver DM1 or the second driver DM2. When viewed in the optical-axis direction, the shape-memory alloy wires SB and the flexible metal member 7 may partially overlap with each other, as illustrated in the lower figure of FIG. 12.

As compared with the configuration in which the flexible metal member 7 is not provided, this configuration has the effect that the energization path including the shape-memory alloy wires SB can be readily secured.

The above-described lens drive device can suppress occurrence of issues concerning holding of the shape-memory alloy wires.

Thus, the preferred embodiment of the present invention has been described in detail. However, the present invention is not limited to the above-described embodiment. The above-described embodiment can be modified and replaced without departing from the scope of the present invention. Each of the features described with reference to the above-described embodiment may be appropriately combined as long as they are not technically inconsistent.

For example, in the above-described embodiment, the metal member 5 is fixed to the corresponding members (each of the lens holder 2, the base member 3, and the support 8) by an adhesive or the like, but may be embedded in the corresponding member or may be a conductive pattern formed on the surface of each member.

What is claimed is:

1. A lens drive device, comprising:
a base member;
a lens holder capable of holding a lens body; and
a driver provided between the base member and the lens holder and including a plurality of shape-memory alloy wires configured to vertically move the lens holder at least in an optical-axis direction, wherein
the shape-memory alloy wires include a first wire and a third wire that cross each other in a side view as viewed from a first direction orthogonal to an optical-axis, and a second wire and a fourth wire that cross each other in a side view as viewed from a second direction orthogonal to the optical-axis and perpendicular to the first direction,
in each of the first wire, the second wire, the third wire, and the fourth wire, one end is fixed to a corresponding lens-side metal member provided on the lens holder, and another end is fixed to a corresponding base-side metal member provided on the base member,
each of the first wire and the second wire is arranged such that a position of the one end is on an upper side of a position of the another end in the optical-axis direction,
each of the third wire and the fourth wire is arranged such that a position of the another end is on an upper side of a position of the one end in the optical-axis direction,
lens-side metal members, each being the lens-side metal member, include a first lens-side metal member to which the one end of the first wire is fixed, a second lens-side metal member to which the one end of the second wire is fixed, a third lens-side metal member to which the one end of the third wire is fixed, and a fourth lens-side metal member to which the one end of the fourth wire is fixed,
the first lens-side metal member and the second lens-side metal member are conductive and connected in series with the first wire and the second wire, and the third lens-side metal member and the fourth lens-side metal member are conductive and connected to the third wire and the fourth wire in series, and
the first lens-side metal member and the third lens-side metal member are arranged on a first side surface of the lens holder separately and adjacent to each other, and the second lens-side metal member and the fourth lens-side metal member are arranged on a second side surface of the lens holder separately and adjacent to each other.

2. The lens drive device according to claim 1, wherein
the lens holder includes a corner portion, and the first side surface of the lens holder and the second side surface of the lens holder are adjacent to each other in a circumferential direction, across the corner portion.

3. The lens drive device according to claim 1, wherein
the first lens-side metal member and the third lens-side metal member are arranged separately and adjacent to each other in an optical-axis direction,
the second lens-side metal member and the fourth lens-side metal member are arranged separately and adjacent to each other in the optical-axis direction,
the first lens-side metal member and the second lens-side metal member include portions in which one of the portions is positioned on an outer side of another of the portions in a radial direction, and the portions are joined together at the portions, and
the third lens-side metal member and the fourth lens-side metal member include portions in which one of the portions is positioned on an outer side of another of the portions in the radial direction, and the portions are joined together at the portions.

4. The lens drive device according to claim 3, wherein
the lens holder includes a corner surface, and
each of the first lens-side metal member, the second lens-side metal member, the third lens-side metal member, and the fourth lens-side metal member includes an extended portion extending along the corner surface, and a pair of corresponding extended portions are joined together.

5. The lens drive device according to claim 4, wherein
the pair of the corresponding extended portions are joined together by welding.

6. The lens drive device according to claim 1, wherein
the base-side metal member includes a first base-side metal member to which the another end of the first wire is fixed, a second base-side metal member to which the another end of the second wire is fixed, a third base-side metal member to which the another end of the third wire is fixed, and a fourth base-side metal member to which the another end of the fourth wire is fixed,
the first base-side metal member and the third base-side metal member are fixed to the first side surface of the base member separately and adjacent to each other, and
the second base-side metal member and the fourth base-side metal member are integrated as a common base-side metal member and fixed to the second side surface of the base member.

7. The lens drive device according to claim 6, wherein
the first wire, the third wire, the first lens-side metal member, the third lens-side metal member, the first base-side metal member, and the third base-side metal member are each doubly provided to form a pair, the optical-axis being interposed between the pair, and
the second wire, the fourth wire, the second lens-side metal member, the fourth lens-side metal member, and the common base-side metal member are each doubly provided to form a pair, the optical-axis being interposed between the pair.

8. The lens drive device according to claim 1, further comprising:
a support disposed on a lower side of the base member, and
another driver configured to move the base member in a direction crossing the optical-axis.

9. A camera module, comprising:
the lens drive device according to claim 1;
the lens body fixed to the lens holder; and
an image sensor facing the lens body.
